(19) United States
(12) Patent Application Publication
(10) Pub. No.: US 2006/0285522 A1
(43) Pub. Date: Dec. 21, 2006

(54) System and method for proportionally fair scheduling

(75) Inventors: Hoon Kim, Seoul (KR); Seung-Young Park, Yongin-si (KR); Sang-Boh Yun, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/437,143

(22) Filed: May 19, 2006

(30) Foreign Application Priority Data
Jun. 16, 2005 (KR) 10-2005-0051969

(51) Int. Cl. H04Q 7/00

(52) U.S. Cl. 370/331

(57) ABSTRACT

A system and a method for proportionally fairscheduling is provided for efficiently exchanging information between a base station and a mobile station in a wireless communication system. The system includes a base station performing proportionally fair (PF) scheduling for data transmission by receiving channel quality information (CQI) fedback-transmitted from plural mobile stations connected to the base station. The base station determines a number of first mobile stations feeding back CQI required by the base station, calculates an actual number of second mobile stations, which have fed back CQI using the CQI received from the plural mobile stations, controls a first scheduling metric value by comparing the number of the first mobile stations with the number of the second mobile stations, and transmits the controlled first scheduling metric value to the plural mobile stations, the first scheduling metric value corresponding to information used for determining if the plural mobile stations feedback-transmit the CQI, and the plural mobile stations determine if the mobile stations feedback-transmit the CQI by comparing the first scheduling metric value received from the base station with second scheduling metric values of the plural mobile stations.

### PRIORITY

This application claims priority to an application entitled “System and Method for Proportional Fairness Scheduling” filed in the Korean Intellectual Property Office on Jun. 16, 2005 and assigned Serial No. 2005-51969, the contents of which are incorporated herein by reference.

### BACKGROUND OF THE INVENTION

1. Field of the Invention

The present invention relates to a system and a method for proportionally fair scheduling, and more particularly to a system and a method for proportionally fair scheduling for efficiently exchanging information between a base station and a mobile station in a wireless communication system.

2. Description of the Related Art

A proportionally fair (PF) scheduling scheme is based on information such as a presently available data rate for each user and an average data rate during a late predetermined interval for each user. Equation (1) shows a scheduling metric (SM) used for a PF scheduler.

$$j = arg max \frac{{r}_{i}}{{R}_{i}} , i = 1 , 2 , … \qquad ( 1 )$$

Herein, i denotes a user index, rᵢ denotes a present possible data rate, Rᵢ denotes an average data rate during a late predetermined interval, and e j is a user index selected by a scheduler. In other words, the PF scheduler selects a user having the greatest value among values obtained by dividing a present possible data rate by an average data rate during a predetermined interval at every scheduling time point. The rᵢ is transmitted through a feedback channel (Channel Quality Information (CQI) Channel) received from a user.

Through this conventional scheduling scheme, a user having the highest priority is selected by using CQI of all users at every time point. Accordingly, when many users perform communication, power loss, overheads, and an amount of interference increase due to the CQI.

### SUMMARY OF THE INVENTION

Accordingly, the present invention has been made to solve the above-mentioned problems occurring in the prior art, and an object of the present invention is to provide a system and a method for proportionally fairscheduling, which perform data scheduling by dynamically controlling the number of users performing transmission of feedback information.

To accomplish the above object, there is provided a system for performing proportionally fair (PF) scheduling and including a base station performing the proportionally fair (PF) scheduling for data transmission by receiving Channel Quality Information (CQI) fedback-transmitted from plural mobile stations connected to the base station, the system including the base station for determining a number of first mobile stations feeding back the Channel Quality Information (CQI) required by the base station, calculating an actual number of second mobile stations, which have fed back CQI using the CQI received from the plural mobile stations, controlling a first scheduling metric value by comparing the number of the first mobile stations with the number of the second mobile stations, and transmitting the controlled first scheduling metric value to the plural mobile stations, the first scheduling metric value corresponding to information used for determining if the plural mobile stations feedback-transmit the CQI, and the plural mobile stations for determining if the mobile stations feedback-transmit the CQI by comparing the first scheduling metric value received from the base station with second scheduling metric values of the plural mobile stations.

According to another aspect of the present invention, there is provided a method for performing proportionally fair (PF) scheduling in a system including a base station performing the proportionally fair (PF) scheduling for data transmission by receiving channel quality information (CQI) fedback-transmitted from plural mobile stations connected to the base station, the method including calculating a number of a first mobile stations having actually fedback-transmitted CQI using CQI received from the plural mobile stations, controlling by the base station a first scheduling metric value by comparing the number of the first mobile stations with a number of the second mobile stations, which feedback-transmit the CQI required by the base station, the first scheduling metric value corresponding to information used for determining if the plural mobile stations feedback-transmit the CQI, transmitting by the base station the first scheduling metric value to the plural mobile stations, and determining by the mobile station if the CQI is fedback-transmitted by comparing the first scheduling metric value with a second scheduling metric value of the mobile station.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram illustrating the structure of a system for proportionally fair (PF) scheduling according to the present invention;

FIG. 2 is a flowchart illustrating a procedure in which a base station controls SMₜₕ which is information for determining CQI feedback transmission according to the present invention;

FIG. 3 is a flowchart illustrating a procedure of determining if a mobile station feedback-transmits CQI according to the present invention;

FIG. 4 is a graph illustrating a simulation result of the present invention in view of the performance of a user;

FIG. 5 is a graph illustrating a probability that a user does not feedback transmit CQI as a simulation result of the present invention;

FIG. 6 is a graph illustrating a probability that a user feedback-transmits CQI according to the number of users as a simulation result of the present invention; and

FIG. 7 is a graph illustrating the performance of a sector according to the number of users as a simulation result of the present invention.

### DETAILED DESCRIPTION OF THE PREFERRED EMBODIMENT

Hereinafter, a preferred embodiment of the present invention will be described in detail with reference to the accompanying drawings. Note that the same or similar components in drawings are designated by the same reference numerals as far as possible although they are shown in different drawings. In the following description of the present invention, a detailed description of known functions and configurations incorporated herein will be omitted when it may make the subject matter of the present invention unclear.

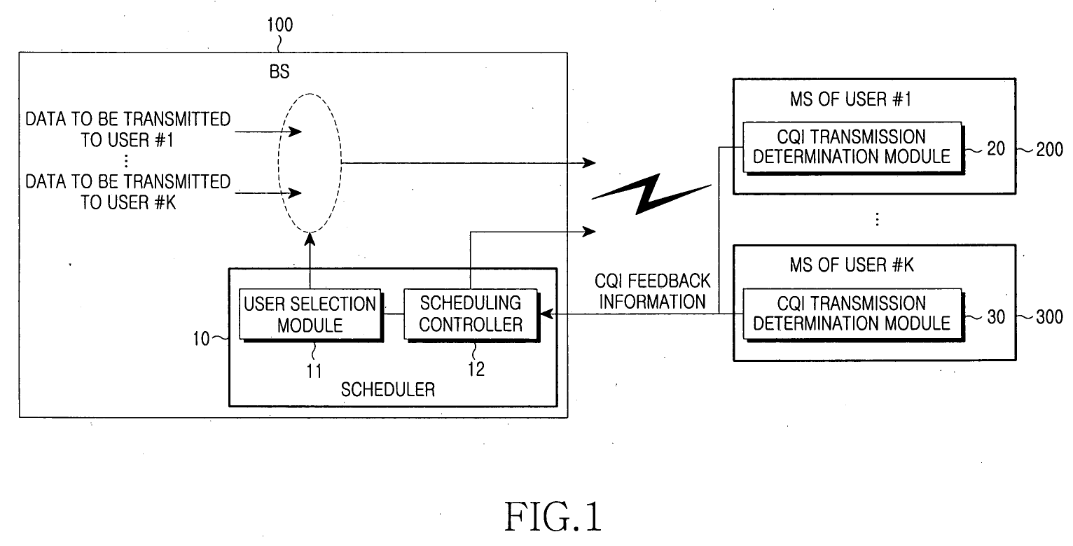

FIG. 1 is a block diagram illustrating the structure of a system for proportionally fair (PF) scheduling according to the present invention.

A scheduler 10 of a base station 100 uses channel quality information (CQI) fedback-transmitted from users in order to perform scheduling with respect to data to be transmitted to the users. In this case, the scheduler 10 can sufficiently perform scheduling using only the CQI of several users instead of the CQI of all users. Accordingly, the scheduler 10 determines the number of CQI to be received therein and transmits information SMₜₕ for determining CQI feedback transmission of users according to the determined number to the users, thereby controlling the number of CQI to be received in the scheduler 10.

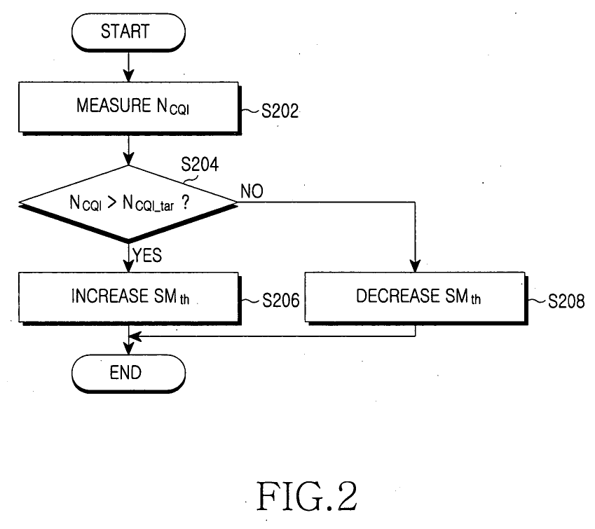

In more detail, the scheduler 10 includes a user selection module 11 and a scheduling controller 12. The user selection module 11 selects users, who receive data at every scheduling time point using CQI of the users received through the scheduling controller 12 and allows the data (which are transmitted to the selected users) to be transmitted through an antenna. The scheduling controller 12 controls information SMₜₕ for determining CQI feedback transmission of users through a procedure shown in FIG. 2 by receiving all pieces of CQI fedback-transmitted from users.

Referring to FIG. 2, upon receiving CQI from users, the scheduling controller 12 measures the number N_{CQI} of users having actually fedback-transmitted the CQI in step S202. The N_{CQI} of users having actually fedback-transmitted the CQI is measured by counting only CQI which is received in the scheduling controller 12 and has a signal-to-interference ratio exceeding a predetermined threshold value.

The scheduling controller 12 determines if the measured N_{CQI} is greater than N_{CQI}_{_{—}}ₜₐᵣ required by the scheduling controller 12 in step S204. N_{CQI}_{_{—}}ₜₐᵣ is the number of users who feedback-transmit CQI, required by the scheduling controller 12. That is, the scheduling controller 12 compares the required number of users who fedback-transmit CQI with the number of users who have actually fedback-transmitted CQI.

If the number N_{CQI} of users having actually fedback-transmitted CQI is greater than the required number N_{CQI}_{_{—}}ₜₐᵣ of users who feedback-transmit CQI as the comparison result, the scheduling controller 12 increases information SMₜₕ for determining CQI feedback transmission of users in step S206. If N_{CQI} is not greater than N_{CQI}_{_{—}}ₜₐᵣ, the scheduler controller 12 decreases SMₜₕ in step 208. SMₜₕ in the first stage is set as a properly low value in preparation for a case where the number of users performing CQI feedback transmission becomes too low. In addition, SMₜₕ in the first stage is determined after the scheduler controller 12 requests all pieces of CQI from all users and determines SMᵢ values of the users. Hereinafter, SMₜₕ is adjusted through the above-described procedure shown in FIG. 2.

In other words, the scheduling controller 12 determines the number of CQI required for scheduling and then increases the value of SMₜₕ if the number of actually received CQI is greater than the required number of the CQI, thereby reducing the number of CQI to be received If the number of actually received CQI is less than the required number of CQI, the scheduling controller 12 decreases the value of the SMₜₕ, thereby increasing the number of CQI to be received.

In the meantime, as shown in FIG. 1, mobile stations 200 and 300 of users, which have received the information SMₜₕ for determining CQI feedback transmission of users from the scheduling controller 12, determine if they transmit CQI.

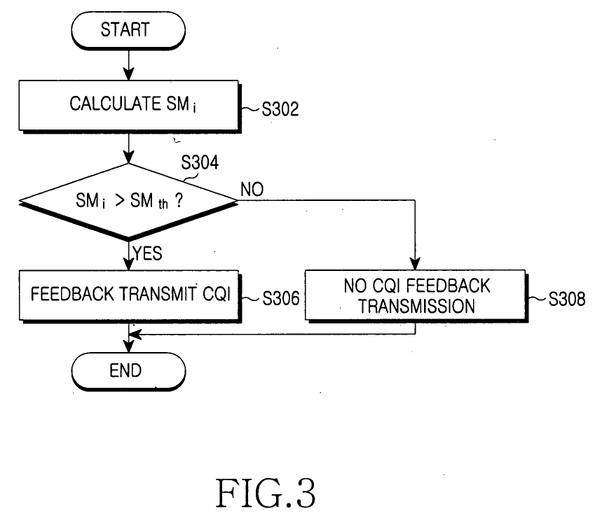

In more detail, the mobile stations 200 and 300 include CQI transmission determination modules 20 and 30, respectively The CQI determination modules 20 and 30 determine if they feedback-transmit CQI through the procedure shown in FIG. 3 using the information SMₜₕ for determining CQI feedback transmission of users.

Refering to FIG. 3, if the CQI transmission determination modules 20 and 30 receive the information SMₜₕ for determining CQI feedback transmission of users, they calculate their own scheduling metric values, SMᵢ (i=1, . . . , K), in step S302. In other words, a corresponding mobile station calculates the scheduling metric value SMᵢ (i=1, . . . , K) with respect to an i^{th} (i=1, . . . , K) user. To this end, according to the present invention, the CQI transmission determination modules 20 and 30 of the mobile stations 200 and 300 have functions capable of calculating the scheduling metric value.

The SMᵢ is defined as rᵢ/Rᵢ in Equation 1 of proportionally fair scheduling. The mobile stations 200 and 300 calculate a present possible data rate rᵢ by measuring link quality of a downlink pilot symbol and a data error rate. Rᵢ denotes an average data rate during a predetermined interval of a downlink and can be measured by calculating an amount of data actually received in the mobile stations 200 and 300.

In addition, each of the CQI transmission determination modules 20 and 30 determines if its own scheduling metric values SMᵢ is greater than the information SMₜₕ for determining CQI feedback transmission of users in step S304.

If the scheduling metric value SMᵢ is greater than the information SMₜₕ for determining CQI feedback transmission of users, the CQI transmission determination modules 20 and 30 transmit CQI to a base station in step S306. If the scheduling metric value SMᵢ is not greater than SMₜₕ, the CQI transmission determination modules 20 and 30 do not transmit CQI to the base station in step S308.

As described above, according to the present invention, it is possible to allow only a mobile station having a scheduling metric value exceeding a scheduling metric value required by a base station to feedback-transmit CQI in a wireless communication system including a mobile station and a base station capable of calculating each scheduling metric value. In addition, the base station adjusts the scheduling metric value by counting the number of received CQI, thereby controlling the number of CQI transmitted from the mobile station.

Hereinafter, a method for controlling the information SMₜₕ for determining CQI feedback transmission of users will be described in more detail.

The information SMₜₕ for determining CQI feedback transmission of users corresponds to a scheduling metric value used for ensuring a probability that the number N_{CQI} of users having actually fedback-transmitted CQI is less than the number N_{CQI}_{_{—}}ₜₐᵣ of users, who feedback-transmit CQI, required by the scheduling controller 12 at every scheduling time point. In other words, this is expressed as Equation (2).
P(N_{CQI}<N_{CQI}_{_{—}}ₜₐᵣ)=δ (2)

Herein, δ is a probability that N_{CQI}<N_{CQI}_{_{—}}ₜₐᵣ.

In this case, on the assumption that a minimum of a variation step size (used for decreasing the information SMₜₕ for determining CQI feedback transmission of users) is Δ, the value of SMₜₕ is decreased or increased by Equation (3) through steps S206 and S208.

$${SM}_{th} ( n ) = \{ \begin{matrix}{SM}_{th} ( n - 1 ) + \frac{δ}{( 1 - δ )} Δ , & if {N}_{CQI} > {N}_{CQI\_tar} \\ {SM}_{th} ( n - 1 ) - Δ , & elsewhere\end{matrix} \qquad ( 3 )$$

In other words, SMₜₕ is decreased or increased by multiplying a previous value thereof by a predetermined variation step size.

In addition, it can be understood that the value of SMₜₕ is repeatedly increased and decreased, so the value thereof is convergent to zero as shown in Equation (4).

$$P ( {N}_{CQI} \geq {N}_{CQI\_tar} ) \frac{δ}{1 - δ} Δ + P ( {N}_{CQI} < {N}_{CQI\_tar} ) ( - Δ ) = ( 1 - δ ) \frac{δ}{1 - δ} Δ + δ ( - Δ ) = 0 \qquad ( 4 )$$

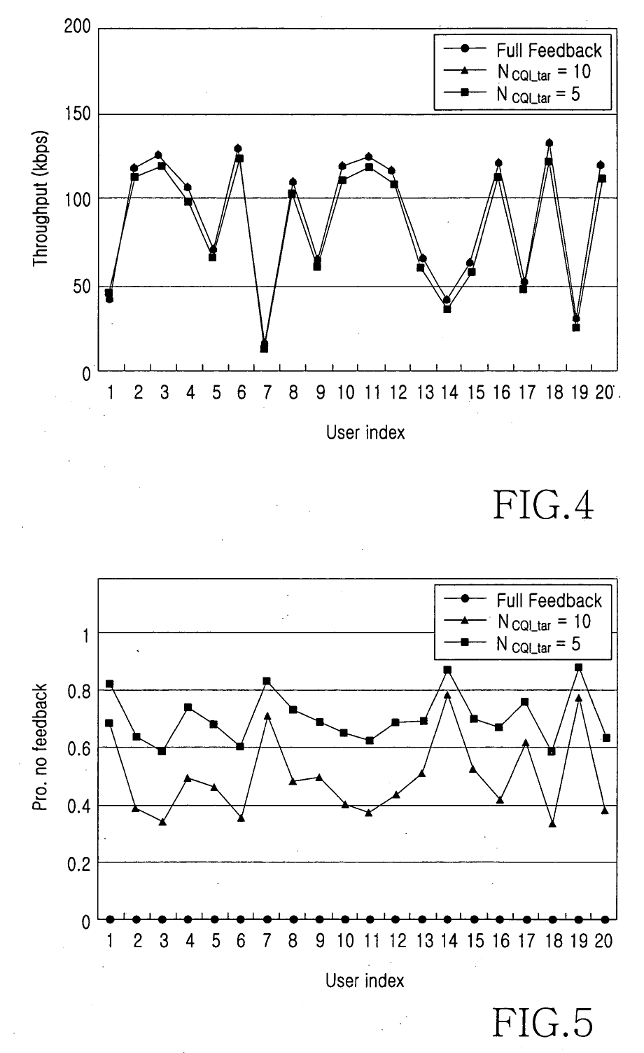

If a simulation is performed with respect to the present invention as described above in an environment having a signal to noise ratio and a data rate shown in Table 2 using parameters shown in Table 1, the result of the simulation is shown in FIGS. 4 to 7.

TABLE 1

| Parameter | Value |
|---|---|
| Number of cells | 19 (3-sector) |
| Target system | HDR |
| Slot duration | 10 msec |
| User distribution | Uniform |
| Path loss model | 128 + 37.6 log10(R) |
| Shadowing | Std: 8Db |
| Fading | Ped. A, 3 km/h |
| CQI report | No feedback error |

TABLE 2

| SNR (dB) | Data Rate (kbps) |
|---|---|
| −12.5 | 38.4 |
| −9.5 | 76.8 |
| −8.5 | 102.6 |
| −6.5 | 153.6 |
| −5.7 | 204.8 |
| −4.0 | 307.2 |
| −1.0 | 614.4 |
| 1.3 | 921.6 |
| 3.0 | 1228.8 |
| 7.2 | 1848.2 |
| 9.5 | 2457.6 |

FIGS. 4 and 5 are graphs illustrating the performance (throughput) of users and a probability that the users do not feedback-transmit CQI when the number of users is 20, Δ=0.25, and δ=0.5. As shown in FIG. 4, although none of users feedback-transmit CQI, the performance is not much different from that of the conventional technique. As shown in FIG. 5, in full feedback, the probability that users do not feedback-transmit CQI is equal to zero. In addition, the smaller the value of N_{CQI}_{_{—}}_{tar,} the higher the probability that users do not feedback-transmit CQI.

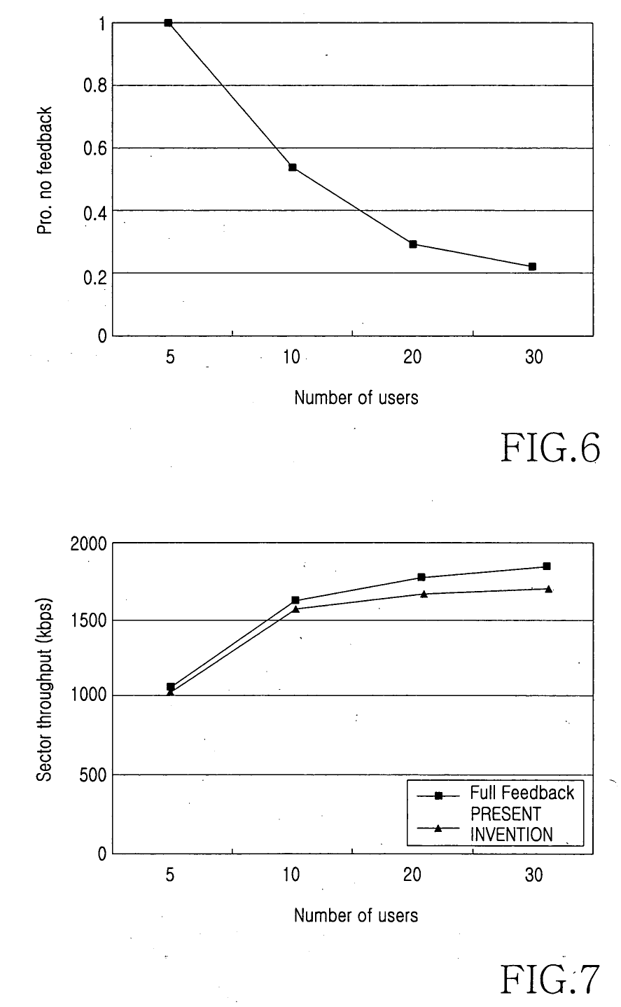

FIGS. 6 and 7 are graphs illustrating a probability that a user feedback-transmits CQI and the performance of a sector according to the number of users when the number N_{CQI}_{_{—}}ₜₐᵣ of users, who feedback-transmit CQI, required by the scheduling controller 12 is 5, Δ=0.25, and δ=0.5. As shown in FIG. 6, since N_{CQI}_{_{—}}ₜₐᵣ is 5, the probability that a user feedback-transmits CQI is 1 when the number of users is 5. As shown in FIG. 7, although the number of users increases, the performance of the sector is not much different from that of the conventional technique.

As described above, according to the present invention, if a base station transmits a threshold value of a scheduling metric value to a mobile station, the mobile station feedback-transmits its own CQI only when its own scheduling metric value exceeds the threshold value, thereby reducing overhead required in scheduling. Accordingly, it is possible to provide a service using low power.

In addition, the present invention is adaptable for a scheduling scheme of requesting the feedback transmission of information from a mobile station.

Furthermore, according to the present invention, it is possible to effectively transmit/receive information usable for scheduling while maintaining system performance similar to that of the conventional technique.

While the invention has been shown and described with reference to certain preferred embodiments thereof, it will be understood by those skilled in the art that various changes in form and details may be made therein without departing from the spirit and scope of the invention. Consequently, the scope of the invention should not be limited to the embodiments, but should be defined by the appended claims and equivalents thereof.

What is claimed is:

1. A system for performing proportionally fair (PF) scheduling, including a base station performing the proportionally fair (PF) scheduling for data transmission by receiving channel quality information (CQI) fedback-transmitted from plural mobile stations connected to the base station, the system comprising:
the base station for determining a number of first mobile stations feeding back the CQI required by the base station, calculating a number of second mobile stations, which have actually fedback-transmitted CQI, using the CQI received from the plural mobile stations, controlling a first scheduling metric value by comparing the number of the first mobile stations with the number of the second mobile stations, and transmitting the controlled first scheduling metric value to the plural mobile stations, the first scheduling metric value corresponding to information used for determining if the plural mobile stations feedback-transmit the CQI; and
the plural mobile stations for determining if the mobile stations feedback-transmit the CQI by comparing the first scheduling metric value received from the base station with second scheduling metric values of the plural mobile stations.

2. The system as claimed in claim 1, wherein the base station calculates the number of the second mobile stations by counting only CQI having a signal-to-interference ratio exceeding a predetermined threshold value, which is received from the plural mobile stations.

3. The system as claimed in claim 1, wherein the base station controls the first scheduling metric value by decreasing the first scheduling metric value if the number of the first mobile stations is greater than the number of the second mobile stations and increasing the first scheduling metric value if the number of the first mobile stations is less than the number of the second mobile stations.

4. The system as claimed in claim 1, wherein the mobile station does not feedback-transmit the CQI to the base station if the first scheduling metric value is greater than the second scheduling metric value and feedback-transmits the CQI to the base station if the first scheduling metric value is less than the second scheduling metric value.

5. A method for performing proportionally fair (PF) scheduling in a system, including a base station performing the proportionally fair (PF) scheduling for data transmission by receiving channel quality information (CQI) fedback-transmitted from plural mobile stations connected to the base station, the method comprising the steps of:
calculating a number of a first mobile stations having actually fedback-transmitted CQI using CQI received from the plural mobile stations;
controlling by the base station a first scheduling metric value by comparing the number of the first mobile stations with a number of the second mobile stations, which feedback-transmits the CQI required by the base station, the first scheduling metric value corresponding to information used for determining if the plural mobile stations feedback-transmit the CQI;
transmitting by the base station the first scheduling metric value to the plural mobile stations; and
determining by the mobile station if the CQI is fedback-transmitted by comparing the first scheduling metric value with a second scheduling metric value of the mobile station.

6. The method as claimed in claim 5, wherein, in the step of calculating a number of the first mobile stations, the number of the first mobile stations is calculated by counting only CQI having a signal-to-interference ratio exceeding a predetermined threshold value, which is received from the plural mobile stations.

7. The method as claimed in claim 5, wherein the step of controlling the first scheduling metric value comprises
increasing the first scheduling metric value if the number of the first mobile stations is greater than the number the second mobile stations; and
decreasing the first scheduling metric value if the number of the first mobile stations is less than the number the second mobile stations.

8. The method as claimed in claim 5, wherein the step of determining if the CQI is fedback-transmitted comprises:
omitting feedback transmission with respect to the CQI if the first scheduling metric value is greater than the second scheduling metric value; and
feedback-transmitting the CQI if the first scheduling metric value is less than the second scheduling metric value.
